(19) United States
(12) Patent Application Publication
(10) Pub. No.: US 2013/0151141 A1
(43) Pub. Date: Jun. 13, 2013

(54) NAVIGATION APPARATUS

(71) Applicant: Denso Corporation, Kariya-city (JP)

(72) Inventors: Gen ORIKASA, Kariya-city (JP); Satoshi NOZOE, Chiryu-city (JP); Yoshiharu MIYACHI, Kawasaki-city (JP); Syoko OOSHIMA, Kariya-city (JP)

(73) Assignee: DENSO CORPORATION, Kariya-city (JP)

(21) Appl. No.: 13/706,411

(22) Filed: Dec. 6, 2012

(30) Foreign Application Priority Data
Dec. 9, 2011 (JP) 2011-270152

(51) Int. Cl. G01C 21/36

(52) U.S. Cl. CPC G01C 21/3626
USPC 701/417

(57) ABSTRACT

A control unit of a navigation apparatus disposed in a vehicle controls a display screen to display a main guidance route. When the vehicle departs from the main guidance route to enter a sub-guidance route at a branch point positioned along the main guidance route, a display mode of a first route between the branch point and a connection point at which the sub-guidance route connects to the main guidance route is gradually changed from a first mode to a third mode, which is a non-display of the guidance route. In addition, the display mode of a second route, which is the sub-guidance route, gradually changes from a second mode to the first mode.

### CROSS REFERENCE TO RELATED APPLICATION

The present application is based on and claims the benefit of priority of Japanese Patent Application No. 2011-270152, filed on Dec. 9, 2011, the disclosure of which is incorporated herein by reference.

### TECHNICAL FIELD

The present disclosure generally relates to the navigation apparatus which performs a route change when a vehicle departs from a set route, or a main guidance route.

### BACKGROUND

Conventionally, when a vehicle departs from a set guidance route, a navigation apparatus in the vehicle performs a re-search by using a re-search function to find and provide a new guidance route. Such navigation apparatus is disclosed in, for example, Japanese Patent Laid-Open No. 2004-61356.

However, during the re-search period, the guidance route displayed on a map image may be in a non-display state (i.e., will disappear), and the vehicle is provided as traveling along a road on the map image that may or may not be the guidance route, due to the non-display state of the guidance route. Such non-display state of the guidance route after departure from the set route may cause the user, especially a novice driver, to feel uneasy and confused, which may further be amplified by the user's notion that he/she has mistakenly departed from the guidance route.

### SUMMARY

In an aspect of the present disclosure a navigation apparatus includes a sub-guidance route search unit to search for a sub-guidance route that connects to, or leads to, a main guidance route when a branch point is provided along the main guidance route. The sub-guidance route departs from the main guidance route at the branch point and may rejoin the main guidance route at a connection point.

The navigation apparatus also includes a route display control unit to control a display unit having a display screen to display a road map on the display screen. In addition to the road map, the route display control unit has the display unit display the main guidance route in a first display mode, the sub-guidance route in a second display mode, and a vehicle mark that indicates a position of the vehicle. The first display mode and the second display mode are respectively different from each other, and both indicating a guidance route set by the navigation apparatus.

Further, when the vehicle departs from the main guidance route at the branch point and enters the sub-guidance route, the route display control unit gradually changes a display mode of a portion of the main guidance route from the first display mode to a third display mode that is realized as a non-display of the guidance route. In particular, the portion of the main guidance route is provided as between the branch point to the connection point, and is designated as a first route. As the display mode of the first route changes, the display mode of the sub-guidance route, which is designated as a second route, changes from the second display mode to the first display mode.

In such manner, when the vehicle departs from the main guidance route at the branch point and enters the sub-guidance route, the display of the main guidance route in the first display mode gradually changes from the first display mode to the third display mode, and the display mode of the sub-guidance route in the second display mode gradually changes from the second display mode to the first display mode, which is dedicated for the display of the main guidance route. Therefore, the route guidance for the driver will be provided without interruption, decreasing the uneasiness and confusion in a positive manner.

The route display control unit displays the sub-guidance route in the second display mode, and may display the sub-guidance route for the branch that is encountered next by the vehicle. In such manner, the display screen may provide a minimum number of sub-guidance routes that are positioned closest to the vehicle, thereby making it easier for the viewer to understand the road map on the display screen of the display unit.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of a navigation apparatus of the present disclosure;

FIG. 2 is a flowchart of a route guidance performed by a control circuit of the navigation apparatus;

FIG. 3 is an illustration of a route guidance display in a first embodiment;

FIG. 4 is an illustration of the route guidance display of FIG. 3 in the first embodiment;

FIG. 5 is an illustration of a route guidance display of the first embodiment;

FIG. 6 is an illustration of a route guidance display of the first embodiment;

FIGS. 7A, 7B, 7C are illustrations of a route guidance display in a second embodiment;

FIGS. 8A, 8B, 8C, 8D, 8E are illustration of a route guidance display in a third embodiment; and

FIGS. 9A, 9B, 9C, 9D, 9E are illustrations of a route guidance display in a fourth embodiment.

### DETAILED DESCRIPTION

### First Embodiment

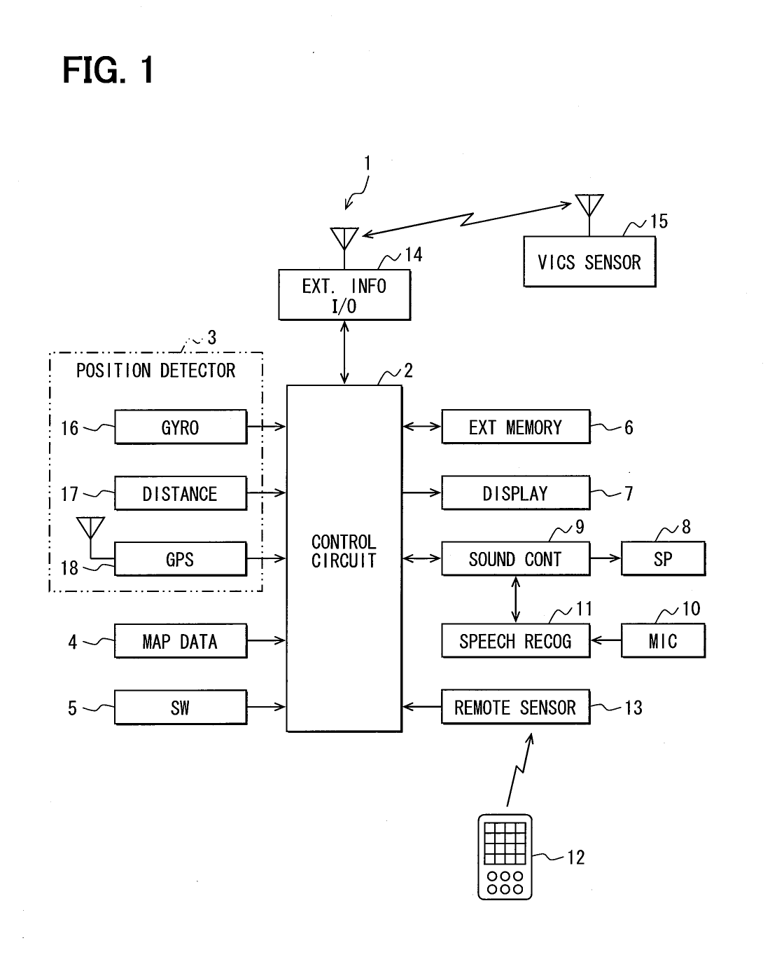

The following description is in regards to the first embodiment of the present disclosure, illustrated with reference to FIG. 1 to FIG. 6.

FIG. 1 is a block diagram of a navigation apparatus 1 disposed in a vehicle. The navigation apparatus 1 includes a control circuit 2, a position detector 3, a map data input unit 4, an operation switch group (SW) 5, and an external memory 6. The control unit 2 has a microcomputer, and may correspond to a main guidance route search unit, a sub-guidance route search unit, and a route display control unit in claims. The position detector 3 detects a current position of the vehicle (current vehicle position hereinafter).

In addition, the navigation apparatus 1 includes a display unit 7, a sound controller 9 that is coupled to a speaker 8, a speech recognition unit 11, a wireless remote controller sensor 13, and an external information input-output device 14. The display unit 7 may be a color liquid crystal display device. The speech recognition unit 11 recognizes a sound input from a microphone 10. The wireless remote controller sensor 13 transmits and receives commands to and from a wireless remote controller 12, and the external information input-output device 14 transmits and receives data through wireless communications to and from an external facility such as, for example, a Vehicle Information and Communication System (VICS) (registered trademark) center 15 and various kinds of information center.

The position detector 3 has a gyroscope 16 detecting the angle of rotation speed of the vehicle, a distance sensor 17 detecting the travel distance of the vehicle, and a GPS receiver 18 for detecting a position of the vehicle based on an electric wave transmitted from a GPS satellite of a Global Positioning System. Each of the sensors 16 to 18 has an error of different nature. Therefore, the control circuit 2 compensates for the errors by mutual compensation between the detection values from the sensors 16, 17, 18, for highly accurate detection of the current vehicle position, a progress direction, a speed, a travel distance, and a current time. Depending on the accuracy, the position detector 3 may have some of the sensors 16 to 18, and is not necessary to have all the sensors 16 to 18.

The position sensor 3 may be supplemented by using other sensors such as a steering rotation sensor for detecting a rotation of a steering wheel and a wheel sensor for detecting a rotation of tires.

The map data input unit 4 at least includes a data read device for reading data from a data medium. The data medium may store road map data, mark data, map matching data, destination data (i.e., facility database), and data conversion table data for converting traffic information into road-associated data. The data medium for storing map data may generally be a large-capacity storage medium such as DVD, but other media such as a memory card and an hard disk drive (HDD) may also be used. The map data input unit 4 may correspond to map data storage in claims.

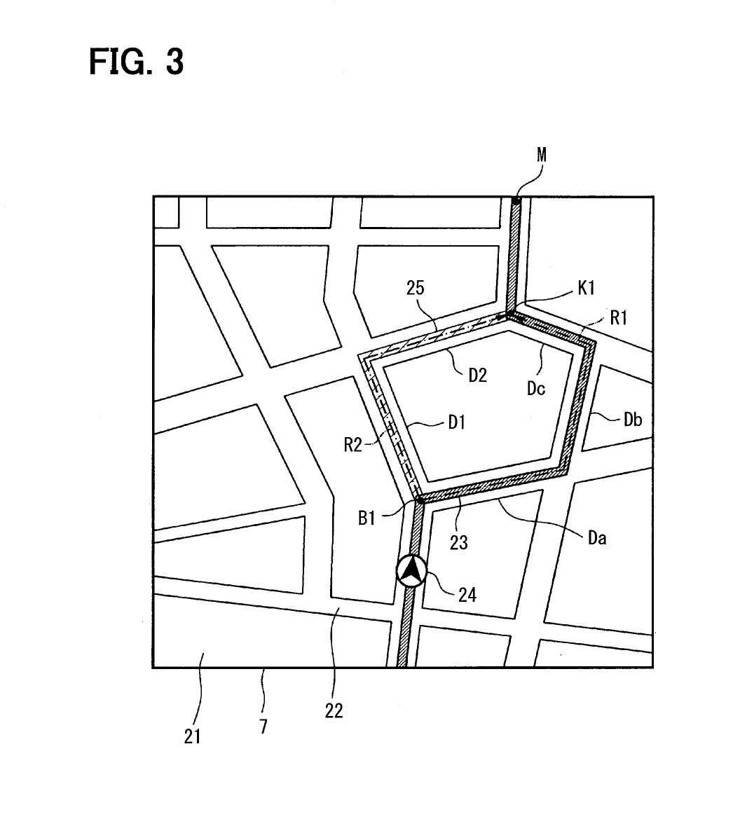

The road map data includes data regarding a road shape, a road width, a road name, a traffic signal, a railroad crossing, a building, various facilities, a place name, a geographical feature, and the like, and also includes data for displaying the road map on a display screen 21 of the display unit 7 (FIG. 3). The destination data is information regarding facilities, shops, residences, and place names, including stations, department stores, and restaurants. Such Information regarding facilities and the like may include, for example, associated telephone number, address, and latitude/longitude, as well as icon data for displaying icons representing respective facilities and the like on the road map.

The operation switch group 5 serves as an input device and includes a mechanical switch established around the display screen 21 of the display unit 7 and a touch panel established on the display screen 21. Accordingly, a user is able to input various commands via the operation switch group 5. For instance, the user may input a destination, information required for destination search (i.e., destination search conditions), waypoints, an effective route/point, and may switch between different display modes and screens of the display unit 7 (e.g., a reduced scale change, a menu display choice, a route search, a route guidance start, a current position correction, a volume adjustment and the like).

Multiple switches are arranged on the wireless remote controller 12 to transmit various instruction signals to the control circuit 2 via the wireless remote controller sensor 13. An operation of the operation switch group 5 and an operation of the wireless remote controller 12 are equivalent in terms of controlling the control circuit 2 to perform a certain function.

The external memory 6 includes a flash memory card. The external memory 6 stores specific data such as main guidance route data set by the control circuit 2 at a time of route guidance, sub-guidance route to be mentioned later, and a travel locus of the vehicle.

The display screen 21 displays a map around the current vehicle position in various scales. In addition, a main guidance route, a sub-guidance route, the current vehicle position, and a progress direction as well as a current position mark (i.e., a pointer) are superimposed on the map around the current vehicle position of the vehicle.

The display screen 21 may also display a guidance screen for a main route guidance leading to a destination when route guidance is performed. An input screen for an input of information by the user, for performing a destination search or the like, may also be displayed in addition to various messages.

The speech recognition unit 11 receives a speech input from the microphone 10, and compares the speech input with the recognition dictionary data in the system to recognize terms or words in the speech input, as a recognized sound. The sound controller 9 controls the speech recognition unit 11, and outputs a speech recognition result to the control circuit 2, and outputs the recognized sound as a repeat speech through the speaker 8. Based on a speech output instruction from the control circuit 2, the speech recognition unit 11 outputs to the speaker 8 various voices such as guidance voices, operation instruction voices, and messages regarding the operation of a theft prevention function. The speaker 8 and the sound controller 9 may serve as an output device.

The microcomputer of the control circuit 2 includes a CPU, a memory (i.e., RAM, ROM, EEPROM, a flash memory), and an input-output together with other parts. The control circuit 2 functions as a destination setting device, a route search unit, a route display control unit, and a route guidance unit based on the execution of a program stored in ROM or in the flash memory by the CPU.

The route search unit includes the main guidance route search unit and the sub-guidance route search unit. The main guidance route search unit automatically determines or searches for a recommended travel route from a departure place (e.g, a current vehicle position) of the vehicle to the destination, by, for example, using a Dijkstra method. The route searched is set as a main guidance route, which is a guidance object, if only one route is found, and, if many routes are found, one of many routes is selected and set as the main guidance route.

The route guidance unit includes a guidance-by-display function (i.e., a route display control unit in claims) and a guidance-by-voice function (i.e., a sound guidance control unit in claims).

The route display control unit displays a road map around the current vehicle position on the display screen 21, so that the vehicle can travel along the main guidance route at a time of searching of the main guidance route. The main guidance route is displayed in a first display mode (e.g., a blue thick line), which indicates that the route is the guidance route, and the sub-guidance route is displayed in a second display mode (e.g., a pale blue thick line), which is in a paler color than the color of the first mode. In addition, a vehicle position mark indicative of the current position of vehicle and the progress direction is displayed on the road map.

The display of the current vehicle position moves over the map according to the travel of the vehicle, and the map is scrolled on the screen according to the position of the vehicle. In the course of such display, map matching to put the vehicle position on the road is performed. Further, the sound guidance control unit provides the sound guidance about the route of the vehicle from the speaker 8.

The present embodiment regarding the operation of the route guidance, including a route search and a route display, under control of the control unit 2 of the present embodiment is described next.

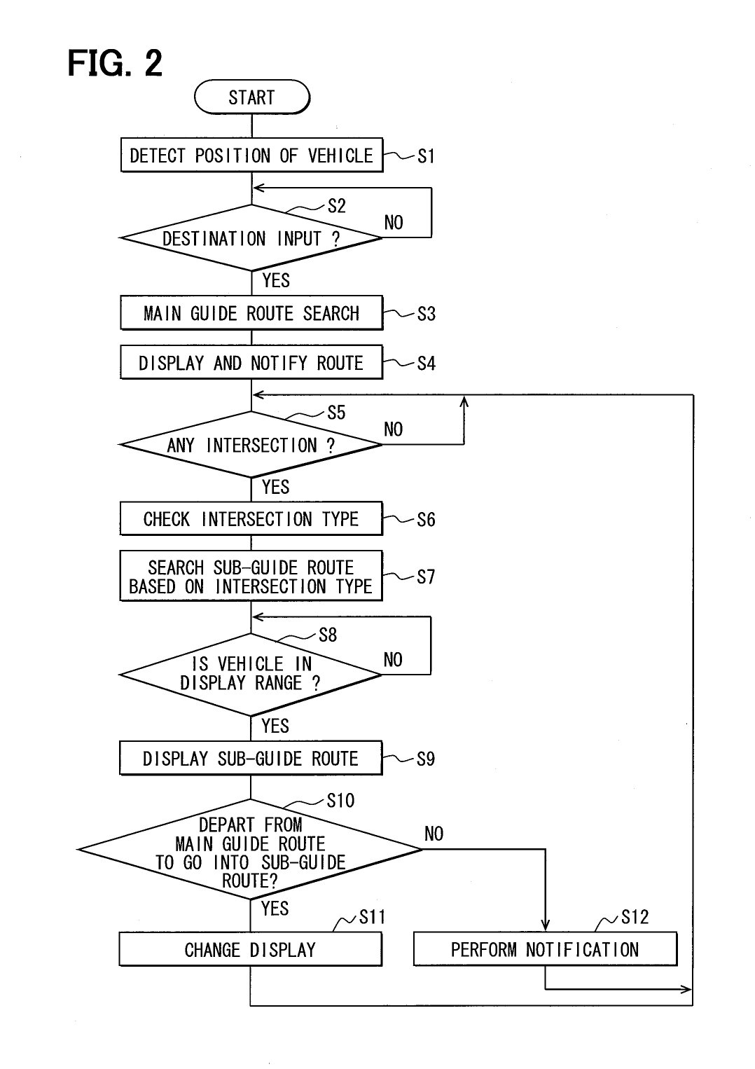

With reference to FIG. 2, in S1, the control unit 2 determines the current vehicle position by using the position detector 3. The control unit 2 then determines whether the user of the vehicle, which may be the driver, has inputted the destination via the operation switch group 5, at S2, and waits until such destination information is provided. When the destination has been inputted (S2: Yes), the control unit 2, at S3, performs a route search to search for a main guidance route between the current vehicle position detected by the position detector 3 (S1) and the destination received via the operation switch group 5 by using the normal Dijkstra method.

After S3, the control unit 2, at S4, displays the main guidance route searched in S3 on the display unit 7 and provides guidance voices for traveling along the main guidance route via the speaker 9. For instance, with reference to FIG. 3, the display screen 21 of the display unit 7 displays a map image 22 of the road map, and, during the route guidance, the main guidance route is displayed in the first display mode, using a bright color thick line (e.g., a blue thick line).

As the vehicle begins traveling along the main guidance route according to the route guidance, and the current vehicle position is detected by the position detector 3. The current vehicle position is indicated on the map image 22 by a vehicle position mark 24, and the vehicle position mark 24 is displayed based on the detection value of the position detector 3, and becomes the progress direction of the vehicle.

In S5, the control unit 2 determines whether there is an intersection on the main guidance route at a position that is in front of the current vehicle position to be traveled by the vehicle. In other words, the process determines whether the vehicle will next encounter a branch point on the main guidance route. If an intersection exists, the control unit 2, at S6, determines an intersection type of the intersection as a two-branch type (i.e., a Y-shape road), a three-branch type (i.e., a crossroad), or a four or more branch type.

In S7 the control unit 2 searches for a sub-guidance route according to the intersection type determined at S6 (i.e., the control unit 2 functions as the sub-guidance route search unit). For example, in FIG. 3, a two-branch type branch point B1 is in front of the current vehicle position. The control unit 2 searches for a sub-guidance route that is different from the main guidance route and is connected to the main guidance route after the branch point B1 (i.e., on a destination side of the branch point B1), such as at a point M. In this case, the sub-guidance route from the branch point B1 and connected to the main guidance route is provided as a route passing a road D1 and a road D2. The connection point connecting the sub-guidance route to the main guidance route is represented as a point K1. Further, the main guidance route between the branch point B1 and the connection point K1 is designated as a first route R1 (i.e., roads Da, Db, Dc), and the sub-guidance route is designated as a second route R2 (i.e., roads D1, D2). Both the first route R1 and the second route R2 are provided with dashed lines in FIG. 3. Such dash lines are for illustration purposes only and are not actually displayed on the screen.

Subsequently, at S8, the control unit 2 determines whether the sub-guidance route enters a display range that is set in advance, and if it is determined that the sub-guidance route has entered the display range (S8, Yes), the control unit 2 displays the sub-guidance route in a display mode different from the display mode of displaying the main guidance route display 23 (i.e., the second display mode). Such display of the sub-guidance route is designated as a sub-guidance route display 25 (FIG. 3). The second display mode may display the sub-guidance route in a pale or lighter color thick line (e.g., a pale blue thick line), which may be the same color as the first display mode but paler.

Next, at S10, the control unit 2 determines whether the vehicle has departed from the main guidance route at the branch point B1 and has entered the sub-guidance route. If the vehicle has not departed from the main guidance route at the branch point B1 (S10, No), the control unit 2 provides navigation notification (i.e., navigation guidance) to the driver of the vehicle at S12.

If the entrance into the sub-guidance route is determined (S10, Yes), the control unit 2 proceeds to S11 to change the route display for the first route R1 (i.e., the main guidance route from the branch point B1 to the connection point K1) and the second route R2 (i.e., the sub-guidance route from the branch point B1 to the connection point K1). The display mode of the first route R1 is gradually changed to turn the bright colored thick line of the first display mode (e.g., a blue thick line) to an invisible route guidance display of a third display mode in which, for instance, the route is not highlighted with a colored line. Also, the display mode of the second route R2 is gradually changed from the pale color thick line of the second display mode (e.g., a pale blue thick line) to the bright color thick line of the first display mode (e.g., a blue thick line).

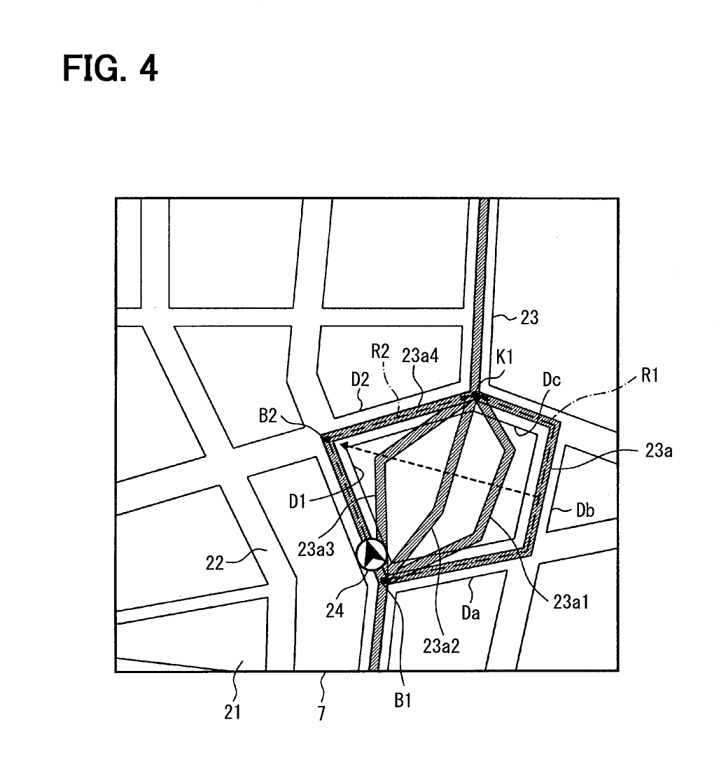

For instance, with reference to FIG. 4, a route display 23a is depicted as gradually changing its shape from the shape of the first route R1 to the shape of the second route R2 (i.e., route displays 23a1 to 23a3) together with a gradual move from the first route R1 to the second route R2 to overlay the second route R2 with a route display 23a4 (i.e., a route display 25 in FIG. 3 is replaced with the route display 23a4 in FIG. 4). As the route display 23a moves from the first route R1 to the second route R2, the route display 23a may be depicted as coupled to the branch point B1 and the connection point K1. The display mode of the first route R1 changes from the first display mode to the third display mode (i.e., the invisible route guidance display) as the route display 23a in the first display mode moves to the second route R2.

Further, the move and the shape change of the route displays 23a, 23a1 to 23a4, which are shown on the display screen 21, are substantially continuous without stepwise move/change. However, stepwise move/change may also be used.

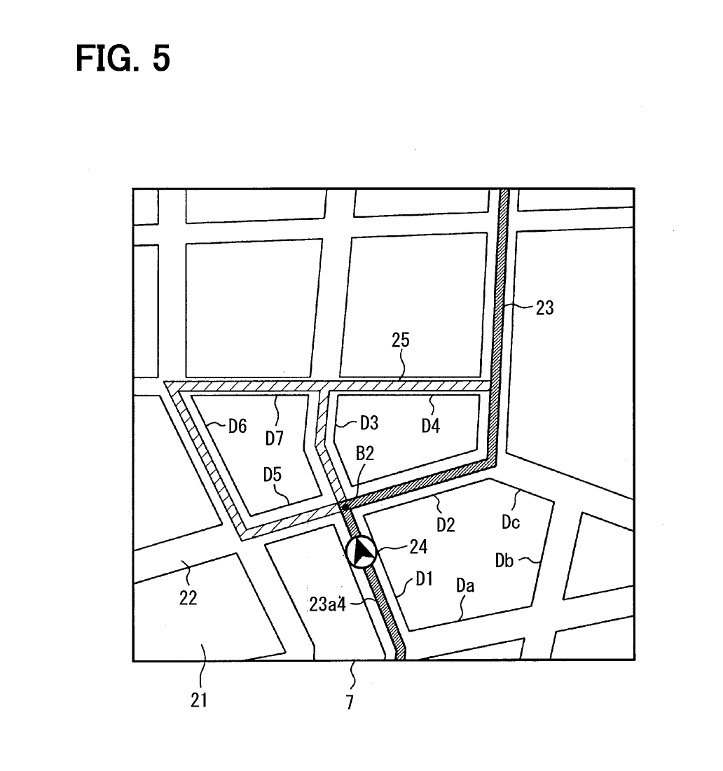

With reference to FIG. 5, in another example, when the vehicle travels on the second route R2, the control unit 2, at S5, determines that there is an intersection in front of the vehicle on the main guidance route (i.e., a branch point B2) to be traveled by the vehicle. Subsequently, at S6, the branch type of the branch point B2 is determined as a three-branch type (a crossroad), and a route search, at S7, results in two sub-guidance routes. In particular, a first sub-guidance route of roads D3, D4 and a second sub-guidance route of roads D5, D6, D7, D4. At S9, the two sub-guidance routes are displayed in the second display mode. On the other hand, for the branch point having three branches or more, at least one sub-guidance route may be displayed, and the other sub-guidance routes may not be displayed. In particular, sub-guidance routes having a longer route distance than the main guidance route by a threshold value may not be displayed.

Further, at S10, when the vehicle is determined to have entered the sub-guidance route from the main guidance route, the control unit 2 may output a soft notification sound from the speaker 8, notifying the driver of the entrance into the sub-guidance route.

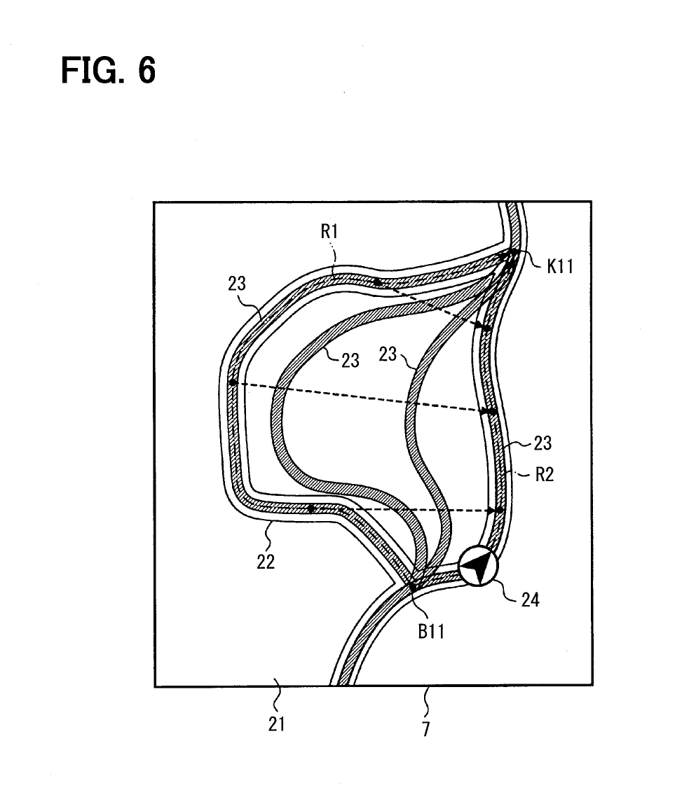

With reference to FIG. 6, the gradual change of the display mode for the first route R1 and the second route R2 may be performed and displayed in the following manner, which may also be performed for FIG. 4. When the vehicle enters the second route R2 at a branch point B11, the shape of the first route R1 represented as a route display 23 may be changed gradually to the shape of the second route R2 such that once the move is completed the second route R2 is depicted by the route display 23 (i.e., the route display 23 overlays the second route R2). In such case, the route display 23 between the branch point B11 and a connection point K11 extends and/or shrinks like a rubber band connecting therebetween while moving from the first route R1 to the second route R2. In such manner, even when the length of the second route R2 is different from the length of the first route R1, such difference of the route length is absorbed, and the difference of the numbers of the right/left turns is also absorbed.

In the example of FIG. 4, a corner of the route display 23 may have an arch or rounded shape during the transfer to further simulate or mimic a motion of the rubber band.

Based on the present embodiment, when the vehicle departs from the first route R1 (i.e., the main guidance route) at the branch point B1 and enters the second route R2 (i.e., the sub-guidance route), the first display mode (i.e., the route display 23) displaying the main guidance route starts to change gradually to the third display mode, which is an invisible route guidance display. In addition, the second display mode displaying the second route R2 (i.e., the sub-guidance route) starts to change gradually to the first display mode for displaying the main guidance route. In such manner, the route guidance for the driver is continuously provided, thereby decreasing the uneasiness and confusion of the driver.

Further, the color and thickness of the first and second display modes may be changed to other colors and/or thickness.

According to the present embodiment, the change from the first route R1 to the second route R2 in the gradual manner, which is displayed on the display screen 21, may be the gradual change of the shape of the first route R1 in the first display mode (i.e., the route display 23a) to the shape of the second route R2, with the movement from the first route R1 to the second route R2 to overlay the second route R2 by the route display 23a (FIG. 4). Also, the display mode of the first route R1 changes from the first display mode to the third display mode as the route display 23a in the first display mode moves to the second route R2.

In such manner, the display of the sub-guidance route, into which the vehicle has entered after the departure from the main guidance route is naturally changed as if the sub-guidance route has been the main guidance route, thereby further decreasing the uneasiness and confusion of the driver. In this case, the change method for FIG. 6 illustration is the same change method for FIG. 4 illustration.

Further, in the present embodiment, the control unit 2 displays the sub-guidance route in the second display mode for the next intersection to be traveled by the vehicle. In such manner, the display of the sub-guidance route is minimum, thereby making it easier for the user to view the display screen of the display unit.

### Other Embodiment

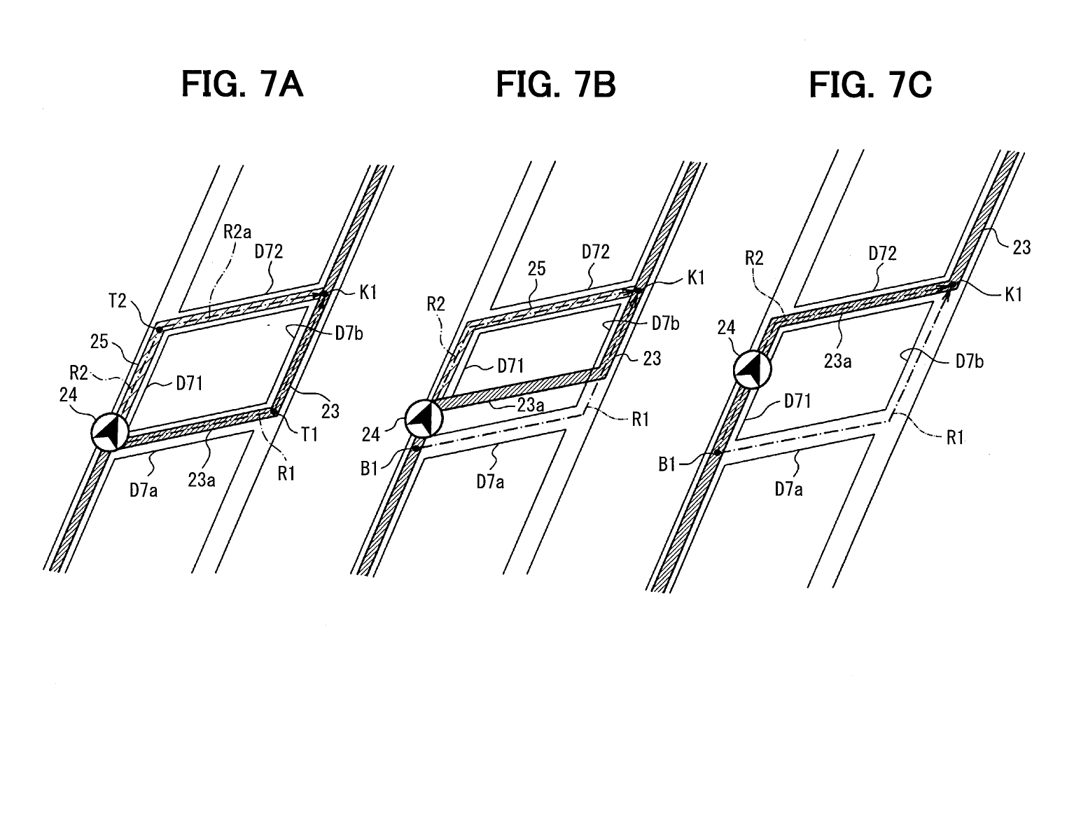

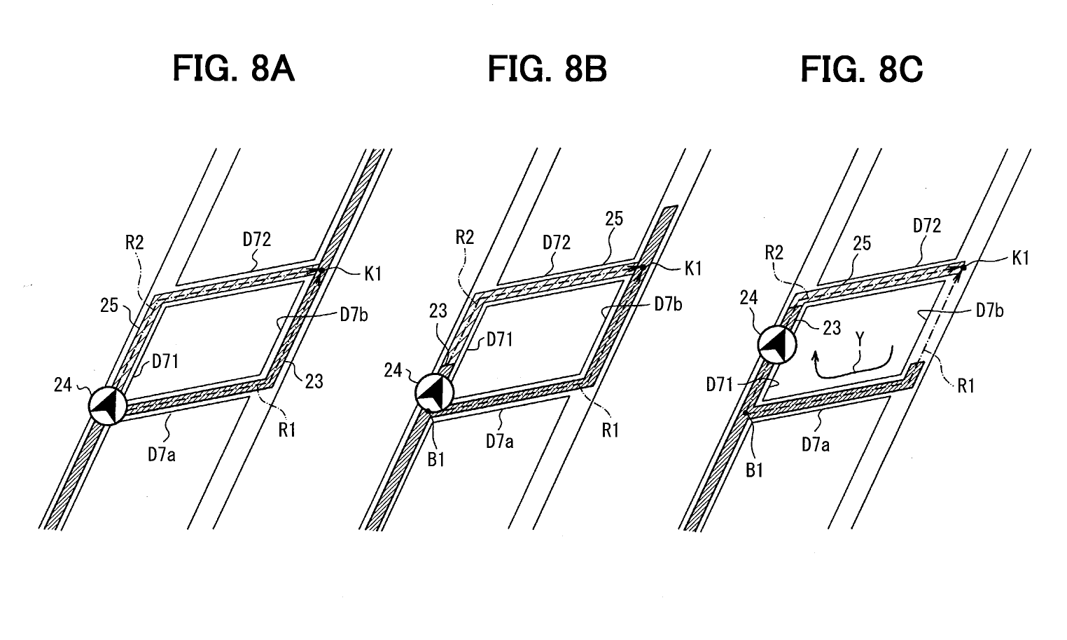

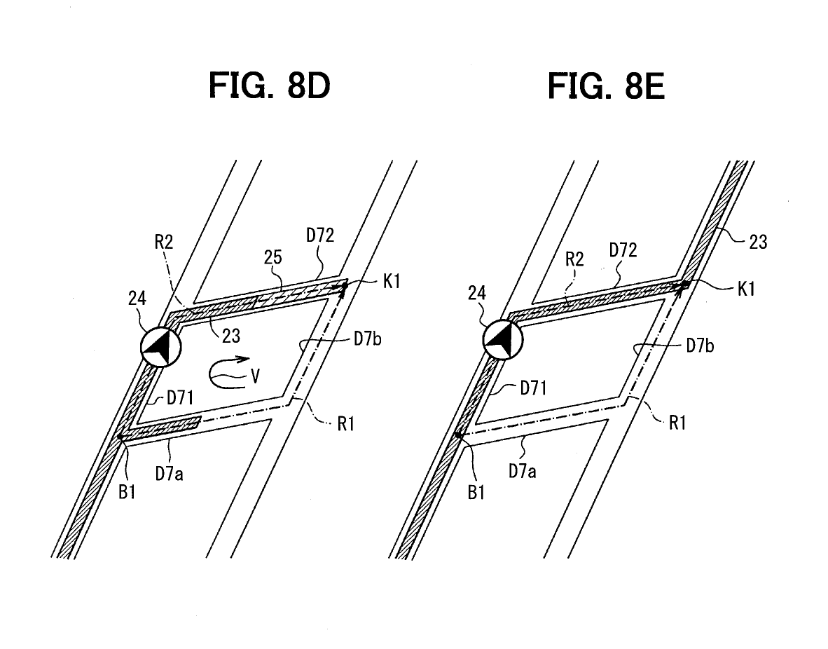

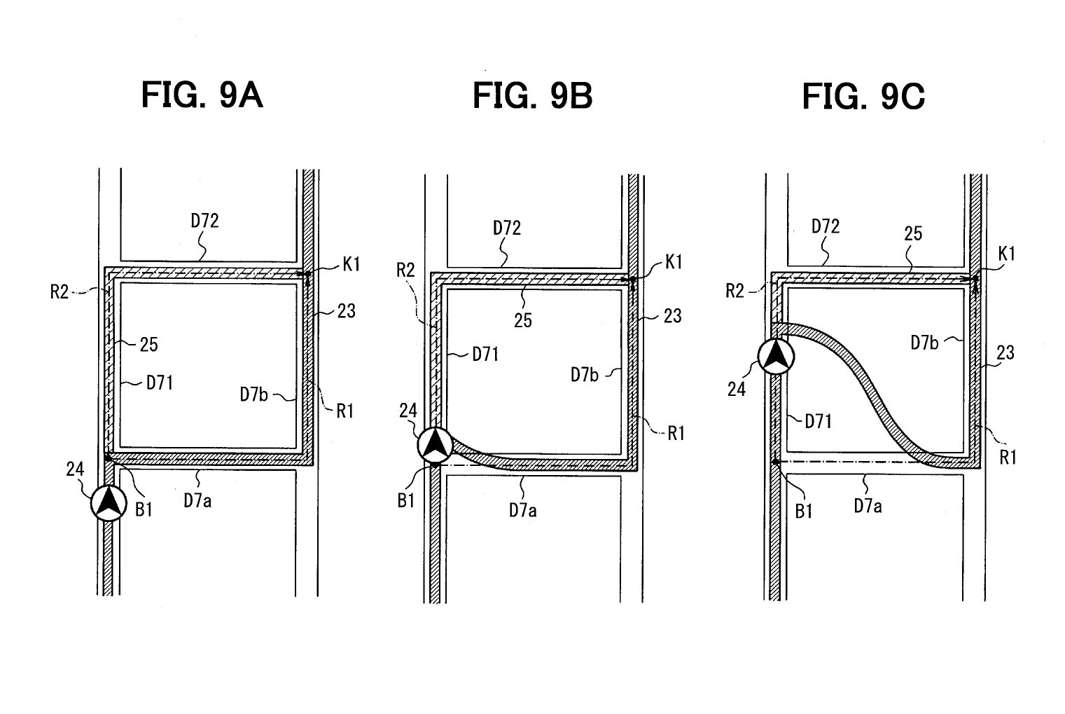

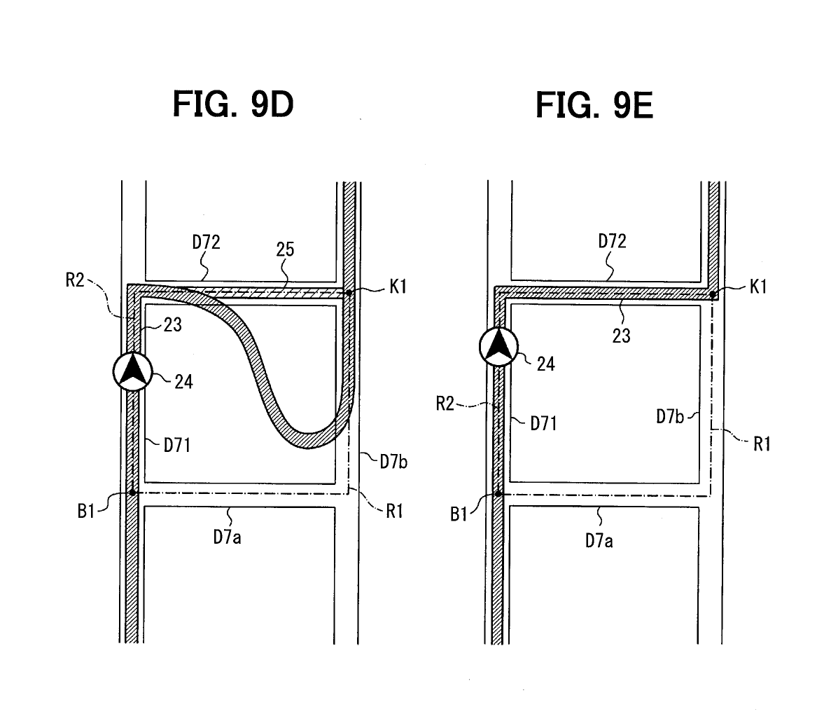

The gradual change of the route display of the first route R1 and the second route R2 may be made in the following manner, as described in the second embodiment with reference to FIG. 7A-7C, the third embodiment with reference to FIG. 8A-8E, and the fourth embodiment with reference to FIGS. 9A-9E. In addition, per the first, second, third and fourth embodiments, like parts are represented by like reference numbers.

With reference to FIGS. 7A-7C, in the second embodiment roads D7a, D7b are the first route R1 serving as the main guidance route, and roads D71, D72 are the second route R2 serving as the sub-guidance route. In FIG. 7A, the first route R1 has a first corner T1 and the second route R2 has a second corner T2. The first route R1 and the second route R2 in combination form a square like shape (i.e., a parallelogram shape).

When the vehicle has entered the second route R2, a portion of the route display 23 partially displaying the first route R1, which is a route display 23a between the branch point B1 and the first corner T1, is moved toward a portion of the second route R2, which is a part R2a between the second corner T2 and the connection point K1 (i.e., toward the road D72). The movement of the route display 23a is a translational movement, keeping the route display 23a in parallel with its original element and with its destination element during the movement (FIG. 7B). After such movement, the second route R2 is then displayed in the first display mode and the first route R1 is displayed in the third display mode (FIG. 7C). In other words, the route display 23a displayed by the first display mode for representing the first route R1 looks as if it is moved in parallel to be fit onto the second route R2 (i.e., a parallel route display). Further, a combined shape of the first route R1 and the second route R2 may have a rectangular shape.

With reference to FIGS. 8A to 8E, which are arranged in a time series, in the third embodiment the route display 23 in the first display mode is made to gradually extend on the second route R2 from the branch point B1 toward the connection point K1 in order to gradually change the route display 25 in the second display mode to the route display 23 in the first display mode. In addition, the route display 23 in the first display mode gradually shrinks on the first route R1 from the connection point K1 toward the branch point B1 in the direction of arrow Y in order to gradually change the first route R1 to the third display mode.

Accordingly, in the direction of the arrow Y, as the first display mode extends along the second route R2 from the branch point B1 to the connection point K1, the first display mode is gradually removed from the first route R1 from the connection point K1 to the branch point B1. Thus, the route display of the second route R2 is changed from the second display mode to the first display mode and the route display of the first route R1 is change from the first display to the third display mode.

The fourth embodiment is shown in FIGS. 9A-9E, which are arranged in a time series. The route display 23 in the first display mode is positioned onto the second route R2 with a portion of the route display 23 gradually peeled off in a direction from the branch point B1 toward the connection point K1 from the first route R1 and moved to the second route R2. In particular, the route display 23 is depicted as being shifted from the first route R1 at a position close to the branch point B1, such that a portion of the route display 23 towards the branch point B1 moves onto the second route R2 with another portion of the route display 23 towards the connection point K1 remains on the first route R1. The route display 23 continues to be shifted (i.e., peeled) along the first route R1 from the branch point B1 to the connection point K1 onto the second route R2 until the route display 23 in the first display mode is over the second route R2 and is no longer on the first route R1.

In other words, the route display 23 in the first mode peels from the first route R1 in a direction from the branch point B1 to the connection point K1, and is positioned onto the second route R2 to replace the route display mode 25 in the second mode. In addition, as the route display 23 in the first mode peels from the first route R1, the route display of the first route R1 is changed to the third display mode.

Accordingly, the route display 23 in the first display mode of the first route R1 is changed to the third display mode and the route display 25 in the second display mode of the second route R2 is changed to the route display 23 in the first display mode. Such change of the route display appears to occur as the vehicle travels along the second route R2, such that based on the movement of the vehicle position mark 24 the route display 23 is peeled off from the first route R1 to be fit onto the second route R2 (i.e., a peel-off display).

In each of the second to fourth embodiments, after the departure of the vehicle from the main guidance route, the newly-entered route is displayed in a gradual or natural-changing manner, as if the newly-entered route had been the main guidance route. Therefore, the uneasiness and confusion of the driver is further decreased.

Further, for example, when it is determined that the vehicle has entered (i.e., has branched into) the main guidance route according to the route guidance in S10 of FIG. 2 (First embodiment), an as-guided flag for storing an as-guided branching according to the route guidance (i.e., without mistake) is turned on, and such memory of as-guided branching may be provided for the driver at a time of subsequent travel of the same branch point, by displaying a smiley icon or the like. In such manner, the driver may be further eased for the driving operation at such branch point, putting his/her mind in a relaxed condition.

In short, based on the present embodiment, a route display control unit (i.e., the control unit 2) controls the display unit 7 to gradually change, during a change of the display mode of the first route R1 and the second route R2, a shape of a route display in the first display mode that has a shape initially representing the first route to a shape of the second route as the route display is moved towards the second route to overlay onto the second route, thereby changing the display mode of the second route from the second mode to the first mode. In addition, the first route R1 changes from the first display mode to the third display mode when the route display moves towards the second route R2.

In such manner, the display of the sub-guidance route, into which the vehicle has entered after departing from the main guidance route, is naturally changed as if the road entered had been the main guidance route, thereby decreasing the uneasiness and confusion of the driver caused by the mistake in following the main guidance route.

The route display control unit may also control the display unit 7 to gradually change, during a change of the display mode of the first route R1 and the second route R2, a route display displayed in the first display mode, which is initially provided on the first route R1 to extend along the second route R2 from the branch point to the connection point to change the display mode of the second route from the second display mode to the first display mode. As the route display extends along the second route R2, it moves off of the first route R1, and the first route R1 gradually changes from the first display mode to the third display from the connection point toward the branch point.

In such manner, the display of the sub-guidance route, into which the vehicle has entered after departing from the main guidance route, is naturally changed as if the road entered had been the main guidance route, thereby further decreasing the uneasiness and confusion of the driver.

In another display change, when the first route has a first corner portion at a middle position of the first route R1 and the second route R2 has a second corner portion at a middle position of the second route R2, the first route R1 and the second route R2 in combination form a substantially square shape. Accordingly, the route display control unit gradually changes a route display in the first display mode representing a section of the first route R1 between the branch point and the first corner portion to move in a direction toward a section of the second route R2 between the second corner and the connection point. After the move of the section of the first route R1 to the section of the second route R2, the second route R2 is changed from the second display mode to the first display mode and the first route R1 is changed from the first display mode to the third display mode.

In such manner, the display of the sub-guidance route, into which the vehicle has entered after departing from the main guidance route, is naturally changed as if the entered road had been the main guidance route, thereby decreasing the uneasiness and confusion of the driver.

The route display control unit may also control the display unit 7 to gradually change a first portion of a route display in the first display mode to extend along the second route R2 from the branch point toward the connection point, and a second portion of the route display in the first display mode extending from the first portion is peeled off from the first route R1 to be moved onto the second route R2 ahead of the first portion to display the second route in the first display mode. When the second portion is peeled from the first route R1, the display mode of the first route R1 is changed from the first display mode to the third display mode.

In such manner, the display of the sub-guidance route, into which the vehicle has entered after departing from the main guidance route, is naturally changed as if the entered road had been the main guidance route, thereby further decreasing the uneasiness and confusion of the driver.

Although the present disclosure has been fully described in connection with the preferred embodiment thereof with reference to the accompanying drawings, it is to be noted that various changes and modifications will become apparent to those skilled in the art, and such changes and modifications are to be understood as being within the scope of the present disclosure as defined by the appended claims.

What is claimed is:

1. A navigation apparatus disposed in a vehicle comprising:
a vehicle position detector detecting a position of the vehicle;
a map data storage storing road map data;
a main guidance route search unit searching the road map data for a main guidance route as a travel route to a destination;
a sub-guidance route search unit searching for a sub-guidance route connecting to the main guidance route at a branch point positioned along the main guidance route, the sub-guidance route departing from the main guidance route at the branch point as a different route from the main guidance route;
a display unit having a display screen; and
a route display control unit controlling the display unit for displaying a road map on the display screen of the display unit with the main guidance route being displayed in a first display mode, the sub-guidance route being displayed in a second display mode, and the position of the vehicle being displayed with a vehicle mark, wherein
the first display mode and the second display mode are respectively different from each other and both indicate a guidance route searched and set by at least one of the main guidance route search unit and the sub-guidance route search unit, and
when the vehicle departs from the main guidance route at the branch point and enters the sub-guidance route, the route display control unit controls the display unit to gradually change a display mode of a first route from the first display mode to a third display mode that is a non-display of the guidance route, and to gradually change the display mode of a second route that is the sub-guidance route from the second display mode to the first display mode, the first route is a portion of the main guidance route between the branch point to a connection point at which the sub-guidance route returns to the main guidance route.

2. The navigation apparatus of claim 1, wherein
the sub-guidance route search unit searches for the sub-guidance route for the branch point that is encountered next by the vehicle.

3. The navigation apparatus of claim 1, wherein
the route display control unit controls the display unit to gradually change, during a change of the display mode of the first route and the second route, a route display provided in the first display mode that has a shape initially representing the first route to a shape of the second route as the route display moves towards the second route and is placed over the second route to display the second route in the first display mode, and the first route changes from the first display mode to the third display mode when the route display moves from the first route.

4. The navigation apparatus of claim 1, wherein
the route display control unit controls the display unit to gradually change, during a change of the display mode of the first route and second route, a route display provided in the first display mode that is initially provided along the first route to extend from the branch point to the connection point along the second route to change the display mode of the second route from the second display mode to the first display mode, and as the route display extends along the second route, the route display is removed from the first route and the first route gradually changes from the first display mode to the third display in a direction from the connection point toward the branch point.

5. The navigation apparatus of claim 1, wherein
the first route and the second route in combination form a substantially square shape when the first route has a first corner portion at a middle position of the first route and the second route has a second corner portion at a middle position of the second route, and
the route display control unit controls the display unit to gradually change, during a change of the display mode of the first route and second route, a route display in the first display mode representing a section of the first route between the branch point and the first corner portion to move in a direction toward a section of the second route between the second corner and the connection point and to display the second route in the first display mode and the first route in the third display mode after the section of the first route is moved onto the section of the second route.

6. The navigation apparatus of claim 1, wherein
the route display control unit controls the display unit to gradually change, during a change of the display mode of the first route and the second route, a first portion of a route display in the first display mode to extend from the branch point toward the connection point along the second route and a second portion of the route display in the first display mode extending from the first portion is peeled from the first route to be moved along the second route ahead of the first portion to change the display mode of the second route to the first display mode and to change the display mode of the first route to the third display mode.
